(19) United States
(12) Patent Application Publication
(10) Pub. No.: US 2018/0024924 A1
(43) Pub. Date: Jan. 25, 2018

(54) ARTIFICIAL INTELLIGENCE-BASED CACHING MECHANISM

(71) Applicant: General Electric Company, Schenectady, NY (US)

(72) Inventor: Steve WINKLER, San Ramon, CA (US)

(21) Appl. No.: 15/218,430

(22) Filed: Jul. 25, 2016

(51) Int. Cl. G06F 12/0808; G06F 12/128; G06F 12/0831

(52) U.S. Cl. CPC G06F 12/0808; G06F 12/0831; G06F 12/128; G06F 2212/621; G06F 2212/69

(57) ABSTRACT

According to some embodiments, system and methods are provided comprising providing one or more applications that can be used by a processor; storing one or more data elements in one or more systems of record; providing a cache associated with the one or more applications; selecting a default cache expiration time via a caching mechanism; determining if the default cache expiration time is met in response to execution of a query associated with the one or more applications; retrieving one or more data elements from the one or more systems of record and transmitting the retrieved one or more data elements to a cache optimization module in response to execution of the query; retrieving one or more cache stored data elements from the cache and transmitting the retrieved one or more cache stored data elements to the cache optimization module in response to execution of the query; determining, via the cache optimization module, whether the retrieved one or more cache stored data elements are the same value as the retrieved one or more stored data elements; invalidating the one or more cache stored data elements if the one or more retrieved cache stored data elements are a different value than the one or more retrieved stored data elements; and adjusting the default cache expiration time in response to the determination whether the retrieved one or more cache stored data elements are the same value as the retrieved one or more stored data elements to optimize a caching strategy. Numerous other aspects are provided.

### BACKGROUND

An application program (“app” or “application”) is a computer program designed to perform a group of coordinated functions, tasks or activities for the benefit of a user, and typically employs data to perform the coordinated functions, tasks and activities.

During execution of an application, the application may access data stored in a cache. As is conventionally known, the cache is a hardware or software component that stores data so future requests for that data may be served faster, as reading data from the cache is typically faster than re-computing a result or reading data from a system of record. Thus, the more requests that may be served from the cache, the faster the system may perform.

Over time the data in the cache may become outdated, and need to be replaced with updated data from the system of record. Applications may typically include a hard-coded date or amount of time between updates of the cache. However, this expiration date may occur too frequently or not frequently enough, resulting in an unnecessary update of data and inaccurate data remaining the cache, respectively. In determining the hard-coded date/amount of time, the application developer may trade speed of supplying data for accuracy of the data.

Therefore, it would be desirable to provide a system and method that more efficiently provides accurate data from a cache.

### BRIEF DESCRIPTION

According to some embodiments, a method includes providing one or more applications that can be used by a processor; storing one or more data elements in one or more systems of record; providing a cache associated with the one or more applications; selecting a default cache expiration time via a caching mechanism; determining if the default cache expiration time is met in response to execution of a query associated with the one or more applications; retrieving one or more data elements from the one or more systems of record and transmitting the retrieved one or more data elements to a cache optimization module in response to execution of the query; retrieving one or more cache stored data elements from the cache and transmitting the retrieved one or more cache stored data elements to the cache optimization module in response to execution of the query; determining, via the cache optimization module, whether the retrieved one or more cache stored data elements are the same value as the retrieved one or more stored data elements; invalidating the one or more cache stored data elements if the one or more retrieved cache stored data elements are a different value than the one or more retrieved stored data elements; and adjusting the default cache expiration time in response to the determination whether the retrieved one or more cache stored data elements are the same value as the retrieved one or more stored data elements to optimize a caching strategy.

According to some embodiments, a system includes one or more systems of record, wherein each system of record includes one or more data elements; a cache operative to store one or more cache stored data elements, wherein the one or more cache stored data elements is a copy of one or more data elements stored in the one or more systems of record; an application operative to receive at least one of the one or more data elements and the one or more cache stored data elements in response to a query; a cache optimization module including a caching mechanism, the caching mechanism operative to: select a default cache expiration time; determine if the default cache expiration time is met in response to execution of a query associated with the one or more applications; retrieve one or more data elements from the one or more systems of record and transmit the retrieved one or more data elements to a cache optimization module in response to execution of the query; retrieve one or more cache stored data elements from the cache and transmit the retrieved one or more cache stored data elements to the cache optimization module in response to execution of the query; determine the retrieved one or more cache stored data elements are the same value as the retrieved one or more stored data elements; invalidate the one or more cache stored data elements if the one or more retrieved cache stored data elements are a different value than the one or more retrieved stored data elements; and optimize a caching strategy by adjusting the default cache expiration time in response to the determination whether the retrieved one or more cache stored data elements are the same value as the retrieved one or more stored data elements.

According to some embodiments, a non-transitory computer-readable medium stores program code, the program code executable by a computer system to cause the computer system to: select a default cache expiration time; determine if the default cache expiration time is met in response to execution of a query associated with one or more applications; retrieve one or more data elements from one or more systems of record, and transmit the one or more data elements to a cache optimization module in response to execution of the query; retrieving one or more cache stored data elements from a cache, and transmit the retrieved one or more cache stored data elements to the cache optimization module in response to execution of the query; determine, via the cache optimization module, whether the retrieved one or more cache stored data elements are the same value as the retrieved one or more stored data elements; invalidate the one or more cache stored data elements if the one or more retrieved cache stored data elements are a different value than the one or more retrieved stored data elements; and optimize a caching strategy by adjusting a default cache expiration time in response to the determination whether the retrieved one or more cache stored data elements are the same value as the retrieved one or more stored data elements.

A technical effect of some embodiments of the invention is an improved technique and system for providing an optimized caching strategy. Embodiments provide a caching mechanism that uses machine learning to update a cache expiration date and optimize a caching strategy. A benefit of embodiments is that by optimizing a caching strategy, via the caching mechanism, more accurate data may be provided to the applications in a more efficient and timely manner. More accurate and efficient applications may result in more effective use of the applications in their associated functions and tasks. Another benefit of embodiments may be the facilitation of application development in that application developers may develop applications without the complexities involved with determining a cache expiration date and hard-coding the cache expiration date into the application.

The inventors also note that a challenge for application developers using conventional caching strategies is that application developers typically take a best guess at a cache expiration date and then program or hard-code the date into the application. Due to the complexities involved in changing the hard-coded date, the cache expiration date is not often changed, despite it being one of too long or too short. For example, a cache having geographic address data elements may be programmed to update every ten years. However, for young adults, their address may change every year, while older adults may change every ten years until a certain age or other characteristic is met (e.g., their children move to a different address and they become “empty-nesters”). For some geographic addresses, the ten year expiration date would be too long, for others too short, and still others just right. The hard-coded cache expiration date may result in the cache returning results to the application query that may be inaccurate in the case of young adults, and unnecessarily using resources to update the cache before any changes. However, selecting a cache expiration date to account for attributes associated with data elements is complex, as is changing the hard-coded cache expiration date. In view of these complexities, application developers trade accuracy of the data for speed of accessing data through the cache when hard-coding the cache expiration date. Embodiments provide a caching mechanism that uses machine learning to optimize a caching strategy that better balances accuracy for speed.

With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a system according to some embodiments.

FIG. 2 illustrates a flow diagram according to some embodiments.

FIG. 3 illustrates a block diagram of a system according to some embodiments.

### DETAILED DESCRIPTION

An application program (“app” or “application”) is a self-contained computer program or piece of software designed to fulfill a particular purpose (e.g., to perform a group of coordinated functions, tasks or activities for the benefit of a user), and typically employs data to perform the coordinated functions, tasks and activities.

During execution of an application, the application may access data stored in a cache. As is conventionally known, the cache is a hardware or software component that stores data so future requests for that data may be served faster, as reading data from the cache is typically faster than re-computing a result or reading data from a system of record. Thus, the more requests that may be served from the cache, the faster the system may perform.

Over time the data in the cache may become outdated, and need to be replaced with updated data from the system of record. Applications may typically include a hard-coded date or amount of time between updates of the cache. However, this expiration date may occur too frequently or not frequently enough, resulting in an unnecessary update of data and inaccurate data remaining the cache, respectively. In determining the hard-coded date/amount of time, the application developer may trade speed of supplying data for accuracy of the data.

Some embodiments provide a system and method that may include a cache optimization module including a caching mechanism to determine whether the cache expiration date should be decreased or increased and then may use a machine learning model to determine the updated expiration date to optimize a caching strategy. As used herein, a caching strategy may refer to the frequency with which the cache is updated and an optimized strategy is one in which the accuracy of the data is balanced with the speed of receipt of the data for a particular application.

Machine learning is a form of artificial intelligence that is used to allow computers to develop behaviors based on empirical data and build analytical models therefrom. A focus of machine learning research may be to automatically learn to recognize complex patterns and make intelligent decisions based on data, without being explicitly programmed where to look. The machine learning models may iteratively learn from data, because as models are exposed to new data, they are able to independently adapt. The machine learning models may learn from previous computations to produce reliable, repeatable decisions and results.

For example, the machine learning model may be trained to suggest the best time for a cache expiration date. The machine learning model may be different for each application and may be trained using historical data elements associated with the application.

In some embodiments, in response to an application requesting one or more data elements, the cache may return the data element if the application's request is before a default cache expiration date; and the system of record may return the data element if the application's request is after the default cache expiration date. In some embodiments, in response to the application's data request, the caching mechanism may pull the data element from both a cache and a system of record. The caching mechanism may then compare the data element pulled from the cache to the data element pulled from the system of record.

In the instance where the default cache expiration date has not passed, if the pulled data element is the same from both the cache and the system of record, the caching mechanism may determine that the cache expiration date is optimal and may remain unchanged, as the data element(s) in the cache is the most up-to-date. Based on the types of data and the usage pattern, the caching mechanism (via the machine learning model) may learn over time when it should pull the data element(s) from the system of record vs reading the data element(s) from the cache.

In the instance where the default cache expiration date has passed, if the pulled data element is the same from both the cache and the system of record, the caching mechanism may determine that the cache expiration date may be extended, as the data element has not changed. The caching mechanism may use machine learning to determine an extended cache expiration date.

In the instance where the default cache expiration date has not passed, if the pulled data element is not the same from the cache as compared to the system of record, the caching mechanism may determine that the cache expiration date may be decreased, so as to reduce the time out-of-date data remains in the cache. The caching mechanism may use machine learning to determine a decreased cache expiration date.

In the instance where the default cache expiration date has passed, if the pulled data element is not the same from the cache as compared to the system of record, the caching mechanism may use machine learning to determine the cache expiration date is optimal and may remain unchanged, as the data in the cache is due to be updated.

In one or more embodiments, a determination that the pulled data element is not the same from the cache as compared to the system of record may initiate an update to both the cache and the machine learning model from the system of record.

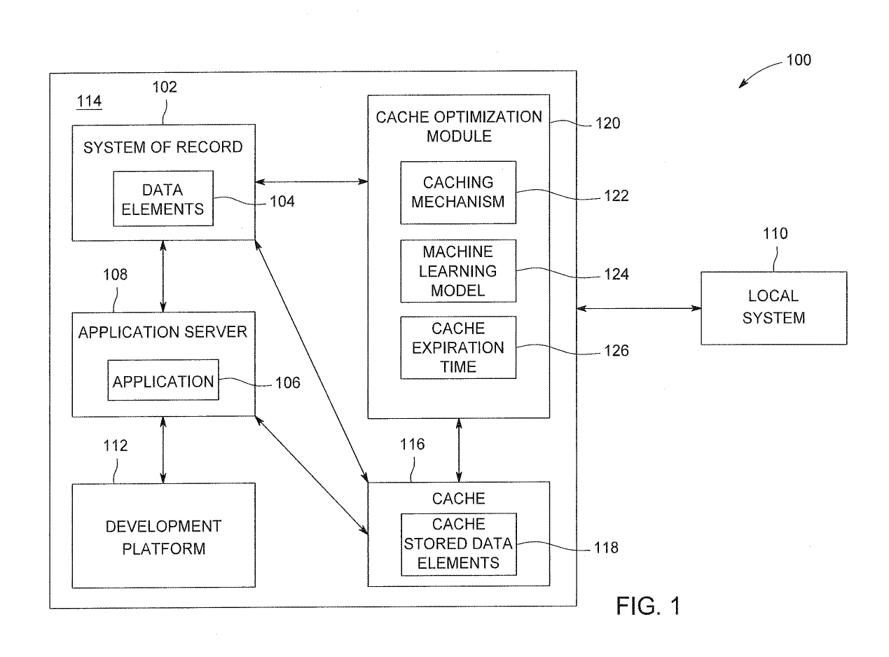

Turning to FIG. 1, a block diagram of a system 100 including a system of record 102 according to some embodiments is provided. As used herein a “system of record” and “datastore” may be used interchangeably. Although the system 100 includes one system of record 102, the system and method described herein may be applied to any system 100 containing any number of a variety of systems of record 102.

The system 100 may also include data elements 104, an application 106, an application server 108, a local system 110, a development platform 112, a computing cloud 114, a cache 116, one or more cache stored data elements 118, a cache optimization module 120, a caching mechanism 122, a machine learning model 124, and a cache expiration time 126.

The system of record 102 may include one or more data element(s) 104 stored in a database, or any other suitable storage. In the case of a database, the system or record 102 may comprise any query-responsive data source or sources that are or become known, including but to limited to a structured-query language (SQL) relational database management system. In the case of a database, the database may comprise a relational database, a multi-dimensional database, an eXtendable Markup Language (XML) document, or any other data storage system storing structured and/or unstructured data. The data element(s) 104 may be distributed among several relational database, dimensional databases, and/or other data sources. Embodiments are not limited to any number or types of data sources.

In instances where the system of record 102 is a database, the system of record 102 may implement an “in-memory” database, in which a full database is stored in volatile (e.g., non-disk-based) memory (e.g., Random Access Memory). The full database may be persisted in and/or backed up to fixed disks (not shown). Embodiments are not limited to an in-memory implementation. For example, data element(s) 104 may be stored in Random Access Memory (e.g., cache memory for storing recently-used data) and one or more fixed disks (e.g., persistent memory for storing their respective portions of the full database).

Applications 106 may comprise server-side executable program code (e.g., compiled code, scripts, etc.) executing within application server 108 to receive queries from a local system 110, or any other suitable query source, and provide results to the local system 110 based on data elements 104 of the system of record 102 or the cache stored data elements 118 of the cache 116. The applications 106 may use Structured Query Langauge (SQL) or other suitable language to manage and query data stored in the system of record 102 and cache 116.

In some embodiments, the system 100 may include a development platform 112 to enable end-users to develop their own applications 106 for interfacing with and optimizing operation of the local system 110 and assets associated with the local system 110. The development platform 112 may be any suitable development platform. While the development platform 112 is in a computing cloud 114 in FIG. 1, or on a premise, the development platform 112 may also reside remote from the computing cloud 114. Such end-user-developed applications 106 may operate by leveraging cloud or distributed computing resources.

The application server 108 may provide any suitable interface(s) through which the local system 110 and an application designer (not shown) working on the development platform 112 may communicate with applications 106 executing on the application server 108. For example, application server 108 may include a HyperText Transfer Protocol (HTTP) interface supporting a transient request/response protocol over Transmission Control Protocol/Internet Protocol (TCP/IP), a Web Socket interface supporting non-transient full-duplex communication which implement the Web Socket protocol over a single TCP/IP connection, and/or an Open Data Protocol (OData) interface. In some embodiments, the application server 108 may provide a comprehensive set of embedded services which provide end-to-end support for Web-based applications. The services may include a lightweight web server, configurable support for OData, server-side JavaScript execution and access to SQL and SQL Script.

The application server 108 may provide application services (e.g., via functional libraries) which applications 106 may use to manage and query the data element(s) 104 of the system of record 102 and/or cache stored data elements 118 stored in the cache 116. In the instance of the system of record 102 being a database, the application server 108 may be used to expose the database data model, with its tables, hierarchies, views and database procedures, to the local system 110. In addition to exposing the data model, the application server 108 may host system series such as a search service.

The system of record 102 may be stored at a client (not shown) or remote from the client in the computing cloud 114. As is well known in the art, “computing cloud,” often referred to as simply “the cloud,” is the delivery of on-demand computing resources (e.g., networks, network bandwidth, servers, processing, memory, storage, applications, data centers, virtual machines and services, etc.) over the Internet on a pay-for-use basis. The computing cloud 114 may provide physical infrastructure and applications that may be remotely accessed by the local system 110.

The systems and methods described herein may include using a “cloud” or remote or distributed computing resource or service. As used herein, the terms “cloud” and “remote” may be used interchangeably in reference to a computing environment. The cloud may be used to receive, relay, transmit, store, analyze or otherwise process information.

In some embodiments, the computing cloud 114 may include at least one processor circuit, at least one database, and a plurality of users or assets that may be in data communication with the computing cloud 114. The computing cloud 114 may include, or may be coupled with, one or more other processor circuits or modules configured to perform a specific task, such as to perform tasks related to asset maintenance, analytics, data storage, security, or some other function.

In some embodiments, the computing cloud 114 may include a local, system, enterprise, or global computing infrastructure that may be optimized for data workloads (industrial and otherwise), secure data communication, and compliance with regulatory requirements.

The data element(s) 104 stored in the system of record 102 (and corresponding cache stored data elements 118 in the cache 116) may include any type of data. For example, data element(s) 104 may include information about industrial assets and their use conditions, such as data gathered from sensors embedded at or near industrial assets themselves. Other suitable data element(s) may be used. The data element(s) 104 may be aggregated, analyzed, and processed in software residing locally (e.g., local system 110) or remotely (e.g., computing cloud 114) from the assets. Industrial assets may include, for example, among other things and without limitation, manufacturing equipment on a production line, wind turbines that generate electricity on a wind farm, healthcare or imaging devices (e.g., X-ray or MRI systems) for use in patient care facilities, or drilling equipment for use in mining operations. The design and implementation of these assets often takes into account both the physics of the task at hand, as well as the environment in which such assets are configured to operate.

In an example, an industrial asset may be outfitted with one or more sensors configured to monitor respective ones of an asset's operations or conditions. Data elements from the one or more sensors can be recorded or transmitted to the computing cloud 114 or other remote computing environment. By bringing such data into the computing cloud 114, new software applications may be constructed via the development platform 112, for example, and new physics-based analytics may be created. Insights gained through analysis of such data may lead to enhanced asset designs, or to enhanced software algorithms for operating the same or similar asset at its edge, that is, at the extremes of its expected or available operating conditions. The inventors note that the analysis and operation of assets may be enhanced by providing an optimized cache strategy.

As referred to above and here, a “local system” 110 may also comprise one or more servers. The server(s) may comprise at least one processor that executes instructions for performing a task. The local system 110, as well as components in the computing cloud 114, may comprise one or more non-transient computer-readable mediums and one or more processors that may execute instructions stored on a non-transient memory to run an application.

As used herein, the term “local” may indicate that devices are connected directly to one another and/or connected over a local area network. The term “local” is also used for convenience herein to distinguish hardware that is not part of a computing cloud, where the computing cloud is located remotely relative to a (local) system. It is understood that devices that connect to each other over the Internet, rather than directly or over a local area network (or similar), are not local to one another. On the other hand, the term “remote” may indicate that devices communicate with one another over the Internet or some other non-local network. Systems that communicate in this fashion are deemed “remote” from one another for convenience of discussion herein.

In some embodiments the local system 110 and development platform 112 may be coupled to the computing cloud 114 and/or any elements within the computing cloud 114 via any suitable wired or wireless communication channel. Any of the elements described with respect to the system 100 may be coupled via any suitable wired or wireless communication channel.

The cache 116 may be a hardware or software component that stores one or more cache stored data elements 118 so that future requests for that data may be served faster. In some embodiments, the cache stored data elements 118 may be the result of an earlier computation or the duplicate of data stored elsewhere (e.g., data elements 104 stored in the system of record 102). Reading or retrieving data from the cache 116 may typically be faster than re-computing a result or reading the data from a slower (e.g., typically larger) and remote system of record 102. As such, the more data requests served from the cache 116, the faster the system may perform. Often active data (e.g., data frequently used by an application) may be cached to shorten data access times, reduce latency, and improve input/output (I/O).

In some embodiments, the cache optimization module 120 may optimize a caching strategy. The cache stored data elements 118 may be stored in the cache 116 because they are requested with relative frequency. Over time, the data elements 104 in the system of record 102, from which the cache stored data elements 104 were duplicated, may be updated or changed, or the data elements 118 in the system of record 102 used by the application 106 to produce a result stored in the cache 116, may be updated. Typically, a cache expiration time is hard-coded into the application such that when the application 106 is executed, the cache stored data elements 118 are returned until the cache expiration time, after which point, the data elements 104 from the system of record 102 are returned and the cache is invalidated. However, conventional cache expiration times may be inefficient as the conventional cache expiration time may be applicable to the entire cache, as opposed to individual data elements. As such, the cache expiration date may be met prematurely for some data elements that may not be invalid yet, and may be met too long after some data elements have become invalid.

While it may be desirable for the applications 106 to use the most up-to-date data elements, the provision of the up-to-date data elements may be balanced with the speed with which the data elements may be provided from the cache 116 versus the system of record 102. In one or more embodiments, the caching strategy may indicate when the application 106 may use data elements 104 stored in the system of record 102, and when the application 106 may use cache stored data elements 118, thereby balancing accuracy of data with speed, as needed.

In one or more embodiments, the cache optimization module 120 may include the caching mechanism 122 and the machine learning model 124, and may use them to optimize the caching strategy. In some embodiments, the caching mechanism 122 may determine whether the cache expiration date should be decreased or increased, as described further below. In some embodiments, the machine learning model 124 may be a multilayer perceptron (MLP) neural network, another multilayer neural network, a decision tree, or a support vector machine.

In some embodiments, the machine learning model 124 may determine an updated expiration date for the cache stored data elements 118. In some embodiments, the machine learning model 124 may iteratively learn from data, because as the model is exposed to new data, it is able to independently adapt. The machine learning model 124 may learn from previous computations to produce reliable, repeatable decisions and results. For example, the machine learning model 124 may receive, as an input, the number of times a query associated with an application 106 is executed in a given amount of time, and/or the frequency with which a data element is used by the application 106, and may base the determination for the updated expiration date on these inputs to optimize the caching strategy. As another example, the input received by the machine learning model 124 may be application-dependent (e.g., customer data). Other suitable inputs may be used. For example, if the application/query is run daily and therefore accesses the data elements daily, but the data elements only change one time a year, the optimal caching strategy may be to keep these data elements in the cache. As another example, if the application/query is run one time a year and the data elements change more frequently, the optimal caching strategy may be to keep these data elements in the system of record and out of the cache.

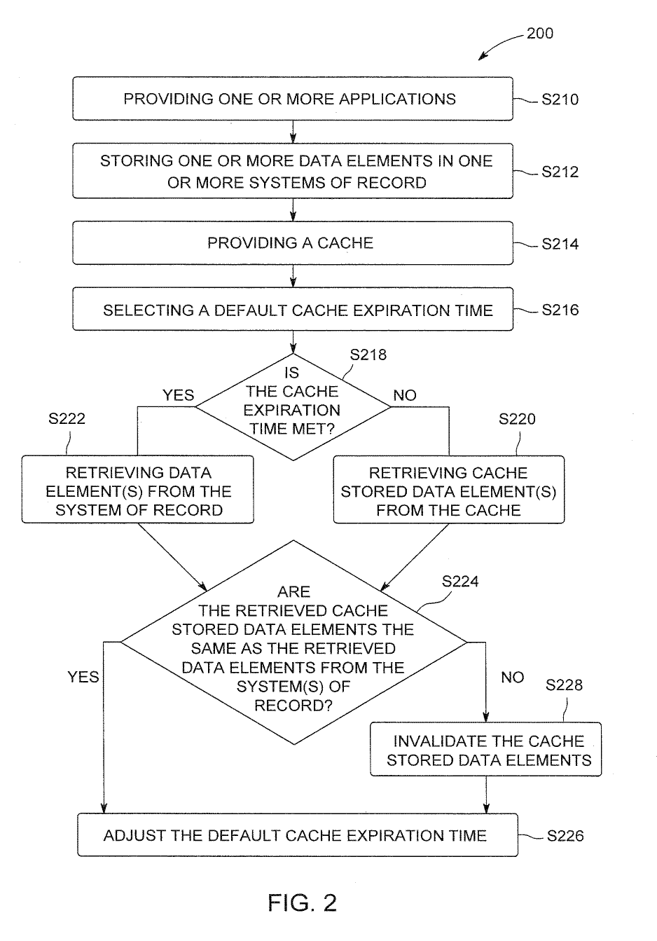

Turning to FIG. 2, an example of operation according to some embodiments is provided. In particular, FIG. 2 is a flow diagram of a process 200 according to some embodiments. Process 200 and other processes described herein may be performed using any suitable combination of hardware (e.g., circuit(s)), software or manual means. In one or more embodiments, the system 100 is conditioned to perform the process 200 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto.

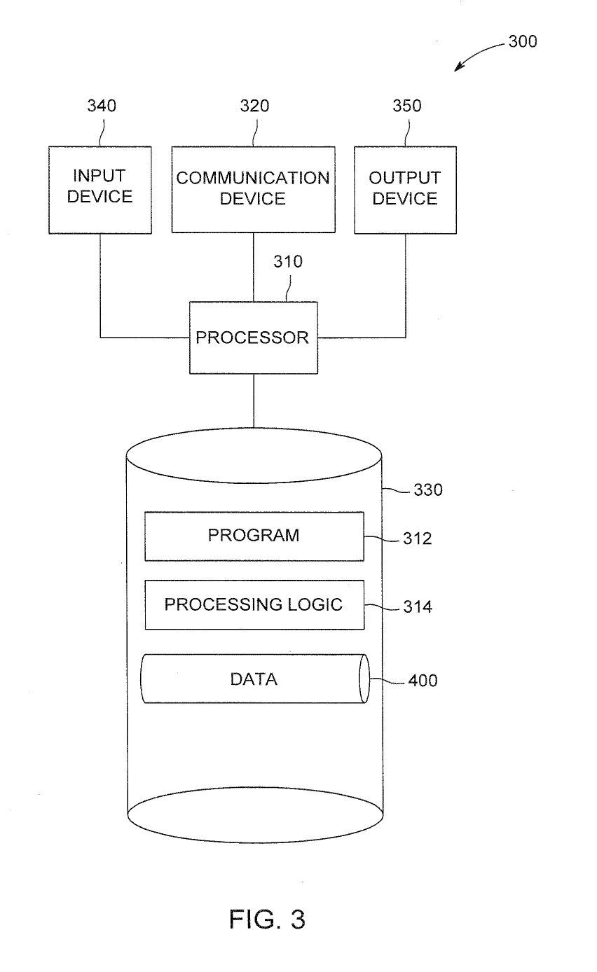

Initially, at S210, the system 100 provides one or more applications 106 that may be used by a processor 310 (FIG. 3). Then in S212, one or more data elements 104 are stored in one or more systems of record 102. In some embodiments, the data elements 104 may be received from an asset about the asset, or from the asset regarding another element or via another data source (not shown).

Then in S214, the cache 116 is provided. As described above, the cache 116 may be associated with one or more applications 106. In some embodiments, in an initial condition (e.g. prior to execution of a query) the cache 116 may be pre-loaded via a pre-load mechanism with cache stored data elements 118 (e.g., a copy of data elements 104 from the system of record 102). In some embodiments, in the initial condition, the cache 116 may be empty and when an application/query is executed, the data element 104 from the system of record 102 may be pulled-through to the cache 116, via a pull-through mechanism to form the cache stored data element 118, such that the data will be loaded to the cache as it is accessed.

A default cache expiration time 126 is selected in S216. In one or more embodiments, the default cache expiration time 126 may be selected by the developer via the development platform 112 during generation of the application 106.

A query is executed, and in response to the query, the application 106 accesses and retrieves data from one of the cache 116 and the system of record 102. In S218 it is determined whether the default cache expiration time 126 has been met, in response to execution of the query. If the default cache expiration time 126 has been met/expired, the data elements 104 are retrieved from the system of record 102, and are returned to the application 106 in S220. If the default cache expiration time 126 has not been met, the cache stored data elements 118 are retrieved from the cache 116 and returned to the application 106 in S222.

In one or more embodiments, at the same time, or at substantially the same time, that the data elements are retrieved from one of the cache and the system of record and returned to the application, the same data elements may be returned to the cache optimization module 120, as well as corresponding data elements retrieved from the other of the cache and system of record. For example, if the default cache expiration time 126 has not been met, and the cache stored data elements 118 are returned to the application 106, the process 200 also retrieves the data elements 104 from the system of record 102 that would have been returned if the default cache expiration time had been met. In some embodiments, the cache optimization module 120 may compare the retrieved cache stored data elements 118 to the retrieved data elements 104 from the system of record 102 to determine whether the retrieved cache stored data elements 118 are the same as the retrieved data elements 104 from the system of record 102 in S224.

If the retrieved cache stored data elements 118 are the same as the retrieved data elements 104 from the system of record 102, the default cache expiration time 126 is adjusted in S226. In some embodiments, the cache optimization module 120 may apply a machine learning model 124 to at least one of the retrieved data, the default cache expiration time, and any other suitable data to determine an updated default cache expiration time 126. For example, if the default cache expiration time 126 has been met, and the data elements 104 from the system of record 102 are the same as the cache stored data elements 118, the machine learning model 124 may recommend to extend the default cache expiration time 126, as the cache stored data elements 118 may still be accurate. As another example, if the default cache expiration time 126 has not been met, and the data elements 104 from the system of record 102 are the same as the cache stored data elements 118, the machine learning model 124 may recommend to maintain the current default cache expiration time 126.

In some embodiments, the recommended adjustment generated by the machine learning model 124 may take effect in S226 automatically with its generation. In some embodiments, the recommended adjustment generated by the machine learning model 124 may not take effect until confirmed by a developer or any other suitable confirmation action.

If the retrieved cache stored data elements 118 are different from the retrieved data elements 104 from the system of record 102, the cache stored data elements 118 may be invalidated in S228, and then the default cache expiration time 126 may be adjusted in S226. In one or more embodiments, the one or more cache stored data elements 118 may be invalided on a per data field level (e.g., geographic address), as opposed to the entire cache being made invalid. For example, if the default cache expiration time 126 has been met, and the data elements 104 from the system of record 102 are not the same as the cache stored data elements 118, the machine learning model 124 may recommend decreasing default cache expiration time 126 to try to get closer to the date the data elements naturally update, or may recommend maintaining the default cache expiration time 126, to optimize the most up-to-date data elements being in the cache. As another example, if the default cache expiration time 126 has not been met, and the data elements 104 from the system of record 102 are different from the cache stored data elements 118, the machine learning model 124 may recommend decreasing the default cache expiration time 126 to optimize the most up-to-date data elements being in the cache.

In one or more embodiments, the determination that the cache stored data elements 118 are different from the data elements 104 stored in the system of record 102 may trigger the cache 116 to update both the cache stored data elements 118 with the data elements 104 stored in the system or record 102 and the machine learning model 124.

Note the embodiments described herein may be implemented using any number of different hardware configurations. For example, FIG. 3 illustrates a cache optimization platform 300 that may be, for example, associated with the system 100 of FIG. 1. The cache optimization platform 300 comprises a cache optimization processor 310 (“processor”), such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more users. The market forecasting platform 300 further includes an input device 340 (e.g., a mouse and/or keyboard to enter information about the measurements and/or assets) and an output device 350 (e.g., to output and display the data and/or recommendations).

The processor 310 also communicates with a memory/storage device 330. The storage device 330 may comprise any appropriate information storage device, including combinations of magnetic storage devices (e.g., a hard disk drive), optical storage devices, mobile telephones, and/or semiconductor memory devices. The storage device 330 may store a program 312 and/or cache optimization logic 314 for controlling the processor 310. The processor 310 performs instructions of the programs 312, 314, and thereby operates in accordance with any of the embodiments described herein. For example, the processor 310 may receive data elements from the cache and system of record and then may apply the cache optimization module 120 via the instructions of the programs 312, 314 to analyze the data and update the caching strategy.

The programs 312, 314 may be stored in a compressed, uncompiled and/or encrypted format. The programs 312, 314 may furthermore include other program elements, such as an operating system, a database management system, and/or device drivers used by the processor 310 to interface with peripheral devices.

As used herein, information may be “received” by or “transmitted” to, for example: (i) the platform 300 from another device; or (ii) a software application or module within the platform 300 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, an analytic module. The method steps can then be carried out using the distinct software modules and/or sub-modules of the system, as described above, executing on one or more hardware processors 310 (FIG. 3). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A method comprising:
providing one or more applications that can be used by a processor;
storing one or more data elements in one or more systems of record;
providing a cache associated with the one or more applications;
selecting a default cache expiration time via a caching mechanism;
determining if the default cache expiration time is met in response to execution of a query associated with the one or more applications;
retrieving one or more data elements from the one or more systems of record and transmitting the retrieved one or more data elements to a cache optimization module in response to execution of the query;
retrieving one or more cache stored data elements from the cache and transmitting the retrieved one or more cache stored data elements to the cache optimization module in response to execution of the query;
determining, via the cache optimization module, whether the retrieved one or more cache stored data elements are the same value as the retrieved one or more stored data elements;
invalidating the one or more cache stored data elements if the one or more retrieved cache stored data elements are a different value than the one or more retrieved stored data elements; and
adjusting the default cache expiration time in response to the determination whether the retrieved one or more cache stored data elements are the same value as the retrieved one or more stored data elements to optimize a caching strategy.

2. The method of claim 1, further comprising:
retrieving the one or more cache stored data elements from the cache in response to execution of the query; and
returning the one or more retrieved cache stored data elements to the one or more applications if the default cache expiration time is unmet.

3. The method of claim 1, further comprising:
retrieving the one or more data elements from the one or more systems of record in response to execution of the query; and
returning the one or more retrieved data elements to the one or more applications if the default cache expiration time is met.

4. The method of claim 1, wherein adjusting the default cache expiration time further comprises:
decreasing the default cache expiration time in response to a determination that the retrieved one or more cache stored data elements is not the same as the retrieved one or more stored data elements.

5. The method of claim 1, wherein adjusting the default cache expiration time further comprises:
extending the default cache expiration time in response to a determination that the retrieved one or more cache stored data elements is not the same as the retrieved one or more stored data elements.

6. The method of claim 1, wherein the one or more cache stored data elements are invalidated on a per data field level.

7. The method of claim 1, further comprising:
determining the frequency of execution of the query.

8. The method of claim 7, further comprising:
adjusting the default cache expiration time based on the determined frequencies to optimize the caching strategy.

9. The method of claim 1, wherein the stored data elements are provided to the cache in the initial condition by at least one of a pull-through mechanism and a pre-load mechanism.

10. The method of claim 1, wherein each of the one or more systems of record is a database.

11. The method of claim 1, further comprising:
employing a machine learning model, via the cache optimization module, to adjust the default cache expiration time.

12. The method of claim 11, wherein the machine learning model is a multilayer perceptron (MLP) neural network, another multilayer neural network, a decision tree, or a support vector machine.

13. A system comprising:
one or more systems of record, wherein each system of record includes one or more data elements;
a cache operative to store one or more cache stored data elements, wherein the one or more cache stored data elements is a copy of one or more data elements stored in the one or more systems of record;
an application operative to receive at least one of the one or more data elements and the one or more cache stored data elements in response to a query;
a cache optimization module including a caching mechanism, the caching mechanism operative to:
select a default cache expiration time;
determine if the default cache expiration time is met in response to execution of a query associated with the one or more applications;
retrieve one or more data elements from the one or more systems of record and transmit the retrieved one or more data elements to a cache optimization module in response to execution of the query;
retrieve one or more cache stored data elements from the cache and transmit the retrieved one or more cache stored data elements to the cache optimization module in response to execution of the query;
determine the retrieved one or more cache stored data elements are the same value as the retrieved one or more stored data elements;
invalidate the one or more cache stored data elements if the one or more retrieved cache stored data elements are a different value than the one or more retrieved stored data elements; and
optimize a caching strategy by adjusting the default cache expiration time in response to the determination whether the retrieved one or more cache stored data elements are the same value as the retrieved one or more stored data elements.

14. The system of claim 13, wherein the one or more cache stored data elements are provided to the one or more applications from the cache if the default cache expiration time is unmet.

15. The system of claim 13, wherein the one or more data elements are provided to the one or more applications from the one or more systems of record if the default cache expiration time is met.

16. The system of claim 13, wherein adjustment to the default cache expiration time includes a decrease in the default cache expiration time in response to a determination that the retrieved one or more cache stored data elements is not the same as the retrieved one or more stored data elements.

17. The system of claim 13, wherein adjustment to the default cache expiration time includes an extension of the default cache expiration time in response to a determination that the retrieved one or more cache stored data elements is not the same as the retrieved one or more stored data elements.

18. The system of claim 13 further comprising a machine learning model, wherein the machine learning model is operative, via the caching mechanism, to adjust the default cache expiration time, the machine learning model basing the adjustment on historical data.

19. A non-transitory computer-readable medium storing program code, the program code executable by a computer system to cause the computer system to:
select a default cache expiration time;
determine if the default cache expiration time is met in response to execution of a query associated with one or more applications;
retrieve one or more data elements from one or more systems of record, and transmit the one or more data elements to a cache optimization module in response to execution of the query;
retrieving one or more cache stored data elements from a cache, and transmit the retrieved one or more cache stored data elements to the cache optimization module in response to execution of the query;
determine, via the cache optimization module, whether the retrieved one or more cache stored data elements are the same value as the retrieved one or more stored data elements;
invalidate the one or more cache stored data elements if the one or more retrieved cache stored data elements are a different value than the one or more retrieved stored data elements; and
optimize a caching strategy by adjusting a default cache expiration time in response to the determination whether the retrieved one or more cache stored data elements are the same value as the retrieved one or more stored data elements.

20. The medium of claim 19, wherein the program code is further executable by the computer system to cause the computer system to:
adjust the default cache expiration time by decreasing the default cache expiration time in response to a determination that the retrieved one or more cache stored data elements is not the same as the retrieved one or more stored data elements.

21. The medium of claim 19, wherein the program code is further executable by the computer system to cause the computer system to:
adjust the default cache expiration time by extending of the default cache expiration time in response to a determination that the retrieved one or more cache stored data elements is not the same as the retrieved one or more stored data elements.
